(19) United States
(12) Patent Application Publication
(10) Pub. No.: US 2007/0025534 A1
(43) Pub. Date: Feb. 1, 2007

(54) Fraud telecommunications pre-checking systems and methods

(76) Inventors: Sudeesh Yezhuvath, Bangalore (IN); Dakshinamurthy Karra, Bangalore (IN)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/178,459

(22) Filed: Jul. 12, 2005

(51) Int. Cl. H04M 15/00

(52) U.S. Cl. 379/114.14

(57) ABSTRACT

Methods and systems for determining a likelihood that a new subscriber for a telecommunications-related service is likely to engage in telecommunications fraud are disclosed. Such methods and systems involve acquiring access to a blacklist database containing a plurality of dada records, each data record containing information on an individual assessed to be a telecommunications fraud risk, and performing one or more textual matching operations between a data record of the new subscriber and at least one record in the first database

### FIELD OF THE INVENTION

This disclosure relates to a computer-based systems for detecting telecommunications fraud.

### BACKGROUND OF THE INVENTION

Telecommunications fraud is perhaps the biggest threat to a telecommunications company in today's market. The International Forum of Irregular Network Access (FIINA), a leading Fraud and Security industry association, estimates a figure for global telecommunications fraud of $60 billion per year, and believes that operators lose as much as 6% of their annual revenue to fraud. Further, FIINA expects those figures to rise with the growing use of next-generation wireless and IP services.

While a number of anti-fraud detection techniques and devices have evolved to counter the problem, such techniques and devices have a number of drawbacks. For example, successful management of telecommunications fraud using conventional approaches requires a fraud monitoring entity to accurately monitor customer usage in order to detect suspicious activity patterns indicative of fraud. Accordingly, it is desirable to develop and deploy new methods and systems capable of providing more accurate and low-cost telecommunications fraud services.

### SUMMARY OF THE INVENTION

In one aspect, an apparatus for determining a likelihood that a new subscriber for a telecommunications-related service is likely to engage in telecommunications fraud includes a blacklist database containing a plurality of dada records, each data record containing information on an individual assessed to be a telecommunications fraud risk, and a fraud detection engine configured to perform one or more textual matching operations between a data record of the new subscriber and at least one record in the first database.

In a second aspect, an apparatus for determining a likelihood that a new subscriber for a telecommunications-related service is likely to engage in telecommunications fraud includes a blacklist database containing a plurality of data records, each data record containing information on an individual assessed to be a telecommunications fraud risk, and a fraud detection means for performing one or more textual matching operations between a data record of the new subscriber and at least one data record in the first database.

In a third aspect, a method for determining a likelihood that a new subscriber for a telecommunications-related service is likely to engage in telecommunications fraud includes acquiring access to a blacklist database containing a plurality of dada records, each data record containing information on an individual assessed to be a telecommunications fraud risk, and performing one or more textual matching operations between a data record of the new subscriber and at least one record in the first database

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a generalized view of an exemplary telecommunications network.

FIG. 2 is an exemplary telecommunications provider for the network of FIG. 1.

FIG. 3 is an exemplary fraud management system capable of monitoring subscriber activity.

FIGS. 4A-4H depict various exemplary textual matching approaches of use in the fraud management system of FIG. 3.

FIG. 5 is a flowchart outlining an exemplary method for fraud detection.

### DETAILED DESCRIPTION

In the world of telephony, there exists a multitude of opportunities for fraud. However, it should be appreciated that the perpetrators of fraud tend to be repeat offenders if given the opportunity. However, since the costs of manufacturing a false identity that can withstand various investigative procedures (such as a simple credit check) can be prohibitive, a substantial portion of repeat offenders do not (or can not) use aliases or false addresses. Accordingly, the present disclosure describes a method and system that exploits this aspect of telecommunications fraud.

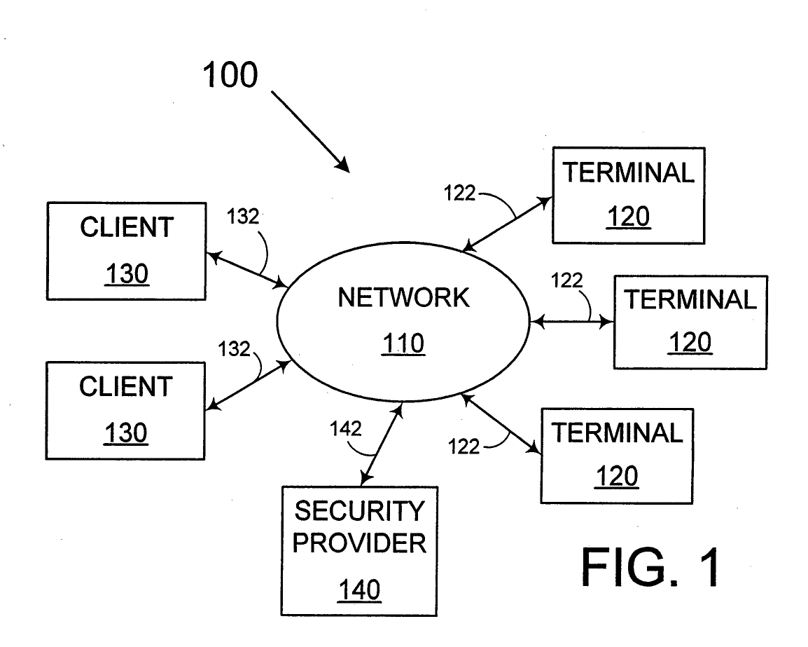

FIG. 1 depicts an exemplary networked-system 100 configured to provide telecommunications services and enable a provider of fraud detection equipment and services to determine a likelihood of telecommunications fraud before it occurs on the networked-system 100. As shown in FIG. 1, the networked-system 100 includes a number of clients 130 coupled to a network 110 via links 132, a number of terminals 120 coupled to the network 100 via respective links 122 and a security client 130 coupled to the network 100 via link 142.

In operation, the clients 130 can each provide a number of telecommunications services for various prospective subscribers, a subscriber being a customer of a client who is generally willing to pay to use the client's telecommunications equipment. In turn, the clients 130 can provide telecommunications services to the subscribers. For example, in a particular embodiment client 130 can be an owner of long-distance telephony equipment having a number of subscribers that sell long-distance services via pre-paid cards. The cards can be purchased by individuals who then gain long-distance access by the network 110 using predetermined codes printed on the cards.

During operation, as each prospective subscriber enlists a client's services, such a subscriber will generally provide certain standard personal information, such as a name, address and the name of an affiliated company or place of employment. While a social security number or a national identification number might be preferable, they are not always available.

Once the subscriber's personal information is received by the client 130, the client 130 can perform a credit check or other standard useful processes.

In addition, the client 130 can send the prospective subscriber's information to the security provider 140 via the network 110. The security provider 140 in turn, can compare the prospective subscriber's information to a “blacklist” database of dada records with each data record containing information on an individual assessed to be a telecommunications fraud risk based on the past behavior of the individual.

For example, if a particular individual had a record of engaging in “callback” fraud with a first telecommunications company/client, then that individual's personal information could be compiled into a database of like individuals along with details of the individual's transgressions. Now supposing that the same individual attempted to engage in callback fraud (or any other type of telecommunications fraud) with a second telecommunications service provider/client. In such an instance, the second telecommunications service provider/client could access the blacklist database and compare the information acquired by the second telecommunications service provider/client to the various records in the database, until a match (if any) was found. A report of the individual could then be compiled and sent to the second telecommunications service provider/client.

The terminals 120 of the immediate example are telephone systems capable of interfacing with a public telephony exchange. However, in various embodiments the terminals 120 can include any of a variety of communication devices, such as personal computers, PDAs, telephones and cell-phones (with and without graphic displays), television sets with special two-way interfaces or any other known or later-developed communication device capable of communicating over a communication network without departing from the spirit and scope of the present disclosure.

The exemplary clients 130 are a collection of telecommunications companies owning/controlling a combination of dedicated telephony circuits and systems for which they provide services to a variety of individuals and companies. However, as with the terminals 120, it should be appreciated that the clients 130 can take any number of forms without departing from the spirit and scope of the present disclosure.

The exemplary network 110 is a public telephony exchange. However, in other embodiments the network 110 can be any viable combination of devices and systems capable of linking computer-based systems including a wide area network, a local area network, a connection over an intranet or extranet, a telephony network, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

The various links 122-142 of the present embodiment are a combination of telephonic devices and software/firmware configured to couple telephony systems to a telephony exchange. However, it should be appreciated that, in differing embodiments, the links 122-142 can take the forms of modems, networks interface card, serial buses, parallel busses, WAN or LAN interfaces, subscriber's line interfaces, T1 interfaces, E1 interfaces, wireless or optical interfaces and the like as may be desired or otherwise dictated by design choice.

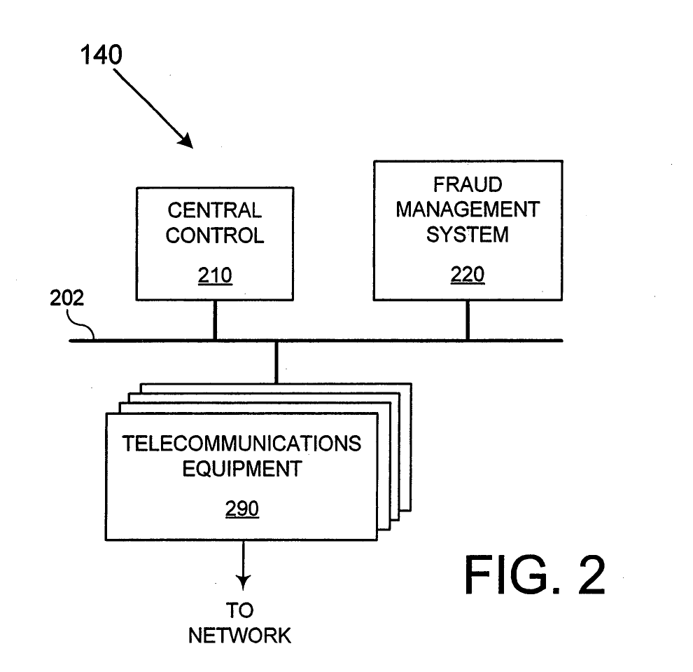

FIG. 2 depicts an exemplary security provider 140. As shown in FIG. 2, the security provider 140 includes a central control device 210, a fraud management system 220 and a bank of telecommunications equipment 290. The above components 210-290 are coupled together by control/data network 202.

In operation, the central control device 210 can be used to configure both the telecommunications equipment 290 and the fraud management system 220. Subsequent to configuration, the telecommunications equipment 290 can receive request from clients to perform a subscriber screening request. Upon receiving a screening request, the fraud management system 220 can send a signal to the central control device 210. In response, the central control device 210 can direct the fraud management system 220 to perform any number of textual matching operations or other pre-screening checks. Once the fraud management system 220 performs its pre-screening checks, the fraud management system 220 can provide an appropriate report to both the central control device 210 and to the client that originated the screening request.

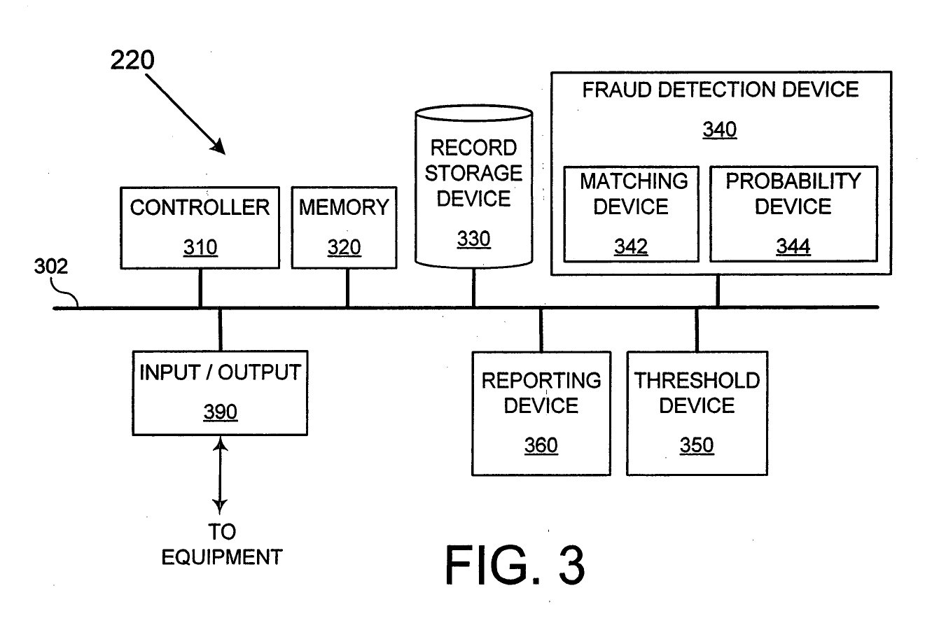

FIG. 3 is an exemplary fraud management system 220 capable of performing a pre-screening check on a prospective subscriber to a telecommunications service. As shown in FIG. 3, the exemplary provider 220 includes a controller 310, a memory 320, a record storage device 330, a fraud detection engine 340 having a matching device 342 and a probability device 344, a threshold device 350, a reporting device 370 and an input/output device 390. The above components 310-390 are coupled together by control/data bus 302.

Although the exemplary fraud management system 220 uses a bussed architecture, it should be appreciated that any other architecture may be used as is well known to those of ordinary skill in the art. For example, in various embodiments, the various components 310-390 can take the form of separate electronic components coupled together via a series of separate busses.

Still further, in other embodiments, one or more of the various components 310-390 can take form of separate servers coupled together via one or more networks. Additionally, it should be appreciated that each of components 310-390 advantageously can be realized using multiple computing devices employed in a cooperative fashion. For example, by employing two or more separate computing devices, e.g., servers, to provide for the fraud detection engine 240 for each alert device 260, a processing bottleneck can be reduced/eliminated and the overall computing time to monitor fraud can be reduced.

It also should be appreciated that some of the above-listed components can take the form of software/firmware routines residing in memory 320 and be capable of being executed by the controller 310, or even software/firmware routines residing in separate memories in separate servers/computers being executed by different controllers. Further, it should be understood that the functions of any or all of components 340-360 can be accomplished using object-oriented software, thus increasing portability, software stability and a host of other advantages not available with non-object-oriented software.

Before fraud pre-screening operations begin, an operator using the fraud management system 220 can first populate a blacklist database in the records storage device 330. Such a database can contain a number of records of each individual or company determined to have performed some form of fraudulent activity upon a telecommunications service provider/client. The information can, in various embodiments, be derived form a large variety of clients. No business relationship need be necessary between clients, and it is envisioned that the clients even can be competitors. The type of information for each blacklist record can include: an individual's first name, an individual's last name, an individual's middle name or middle initial, a company associated with the individual and the type of fraud(s) associated with the individual.

During operation, a record relating to a prospective subscriber can be received via the input/output device 390 and provided to the fraud detection device 240. Next, the fraud detection device 240 can access the blacklist database in the record storage device 330, and perform a variety of textual matching operation between the received record and the individual blacklist records.

Generally, the types of textual matching operations can performed according to a hierarchy which is relevant to the accuracy of the final results. The type of matches include, by order of preference: an exact match, a phonetic match, a cross match and a word match. Variants of the various matching operations can also be performed as will be explained below. As each match for different matching operations can be easier to process or perhaps more significant than another match type, the probability device 344 (which is optional in many embodiments) can be configured to account for such differences.

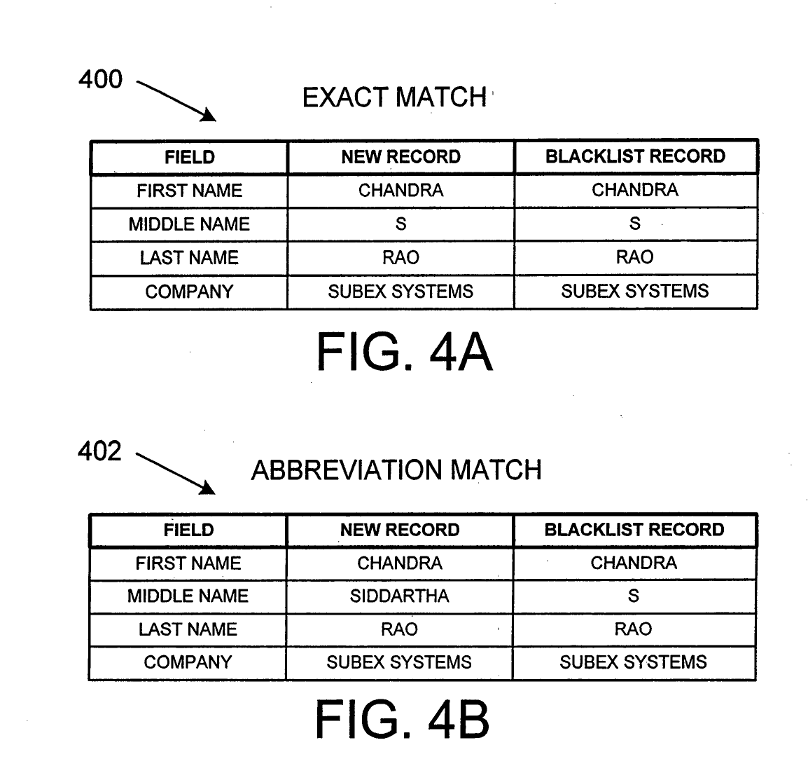

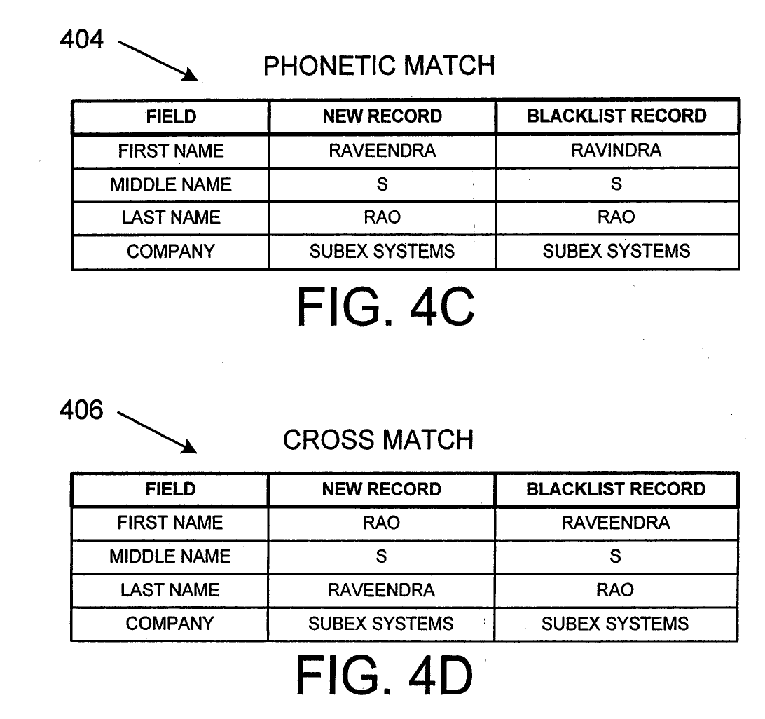

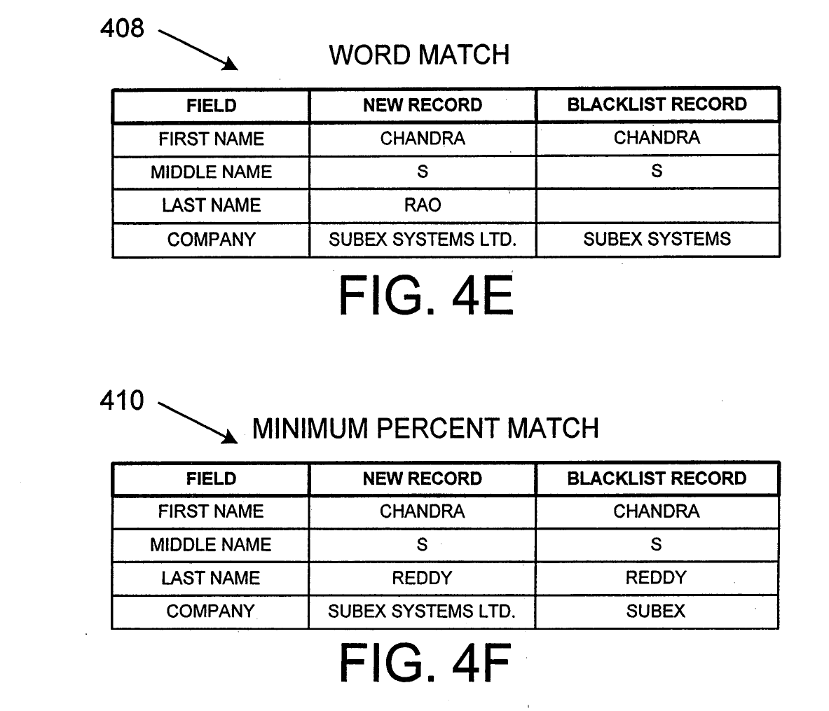

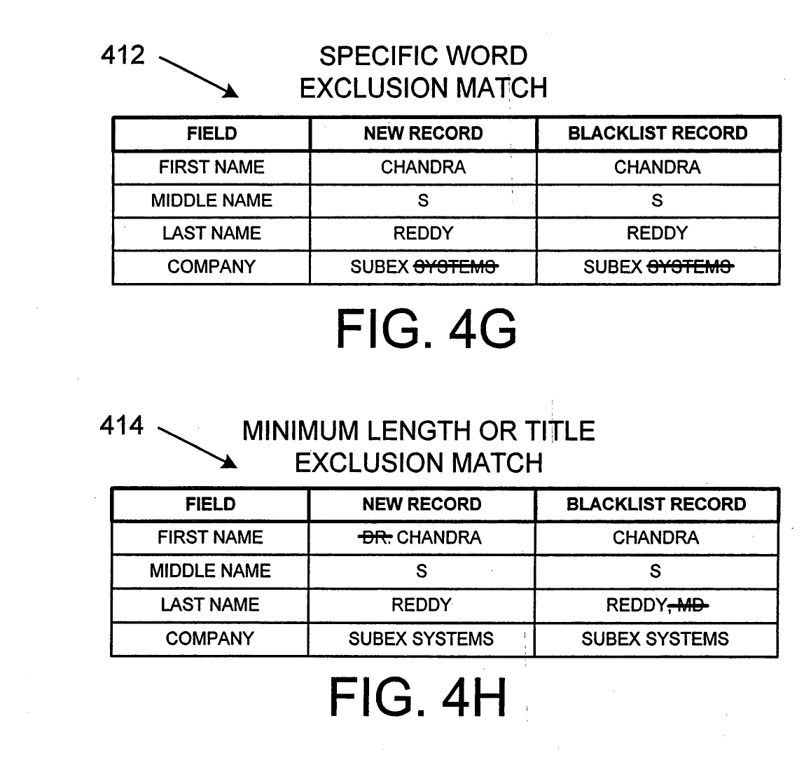

FIG. 4A depicts a first matching operation referred to as an “exact match” operation. As shown in FIG. 4A, the exact match compares each field (first name, middle name, last name, affiliated company) on a character by character basis. Should a perfect match be found in for each field of a prospective subscriber and a blacklist record, a score will be assigned and optionally weighted. For the example of FIG. 4A, each of the matching four fields can be assigned a “1” for a match and a “0” for no match. Assuming a weight of w=0.25 for each exact match, the final tally for the example of FIG. 4A will be (1)(0.25)+(1)(0.25)+(1)(0.25)+(1)(0.25)=1.00.

Returning to FIG. 3, once the fraud detection device 340 has performed an exact match and optionally assigned weights, the results of the match can be passed to the threshold device 350 to determine whether the results meet a minimum criteria. For example, in order to determine whether a match has occurred, the threshold device 350 might require a minimum 0.90 score. For the example of FIG. 4A above, an exact match of all fields would be required as even a mismatch between a single pair of respective fields would result in a 0.75 score. As even a small, generally meaningless difference in a single field may provide a false negative result, it is apparent that other tests can be desirable.

It should be appreciated that the exact match operation may not need any sum of products weighting to operate properly. For example, by simply requiring an exact match of each pair of respective fields and performing a number of Boolean operations, a final 1/0 score can be realized. With this in mind, it should also be appreciated that such an alternative approach of matches and Boolean operations might be alternatively applied throughout the following examples as well. Other combinations of Boolean, statistical, fuzzy-logic, neural processing and other operations may similarly be applied and should be considered substantial equivalents to the disclosed embodiments.

FIG. 4B depicts a variant of FIG. 4A referred to as an “abbreviation match” where the matching device 342 can be configured to account for a common practice where a subscriber may arbitrarily/optionally enter a middle initial or full middle name. While the example of FIG. 4B is depicted with a middle initial example, the abbreviation match can extend to other fields. For example, a subscriber having a first name “Aristotle” may prefer to enter a first initial “A” or the name “Ari”. Similarly, a subscriber may sometimes optionally enter a corporate suffix “Limited” or use the abbreviated form “Ltd.”

In processing the abbreviation match, the probability device 344 can optionally assign the same weights as with an exact match or optionally assign a discounted weight. For example, viewing FIG. 4B it should be appreciated that the probability device 344 can assign a weight of w=0.25 for both a middle-name entry of an “S” as well as the entry “Siddartha” (or any middle name beginning with an “S”). Optionally, the probability device 344 might assign a weight of w=0.20 for instances where a middle name and middle initial are consistent. The same approach can be applied to shortened names. Further, it might be appreciated that the probability device 344 might assign a weight of w=0.25 for both a consistent but mismatching company suffix “Limited” versus “Ltd.” as the shorten version has a well understood meaning. As with the example of FIG. 4A, all weighting may be supplanted with other combinations of Boolean, statistical and other operations.

Returning to FIG. 3, assuming that the fraud detection device 340 has performed an exact match of the records in FIG. 4B (with subsequent negative results), and assuming that the probability device 344 is now performing an abbreviated match and has assigned a weight of w=0.20 for instances where a middle name and middle initial are consistent but don't match exactly, the score produced by the fraud detection device 340 for the example of FIG. 4B would be 0.25+0.20+0.25+0.25=0.95, which would be sufficient for a threshold of 0.90.

Continuing to FIG. 4C, a “phonetic match” is explained. Due to the various differences in languages, e.g., English and Hindi, the existence of a 1-to-1 correspondence between spellings between one language and another may not exist. Accordingly, the matching device 342 in FIG. 3 can be configured to account for such problems by looking for phonetic equivalents, and the probability device 344 can look for all potential phonetic equivalents to a particular name and optionally assign weights based on a level of phonetic similarity. For the example of FIG. 4C, the entries “Raveendra” and “Ravindra” are obviously not exact matches, but otherwise close enough that the probability device 344 might assign a high weight, e.g., 0.25, to the phonetic match. Other circumstances showing lesser phonetic similarities, e.g., “Revindra” and “Ravindra” might be assigned a slightly lower weight, e.g., 0.22, while an even lesser phonetic similarity, e.g., “Rivendray” and “Ravindra” might be assigned an even lower weight, e.g., 0.10. As with the previous examples of FIGS. 4A and 4B, the results of the matching operation can be applied to the threshold device 350 of FIG. 3 and a final assessment made. Should the matching score not meet the required threshold, yet more tests might be applied.

FIG. 4D depicts a fourth test, referred to as a “cross match”, with reflects the occurrence where a subscriber has accidentally or intentionally switched fields. Should a switch in fields occur, the matching device 342 can be configured to account for such a switch, with the probability device 344 optionally applying weighted results. While the example of FIG. 4D requires a perfect match between the first-name and last-name fields, it should be appreciated that the cross match can be optionally modified to also account for abbreviations and phonetics as discussed above, as well as adjusted to account for any of the other issues discussed below.

FIG. 4E depicts a “word match” operation, which is designed to account for situations where a subscriber enters natural variations of a name and/or neglects to enter a specific field. For this scenario, the final score can be determined based on the total number of matching words (or a percentage of matching words) between the new record and the blacklist record. As with the previous examples, weighting may be applied. For the example of FIG. 4E, there is a missing last name in the blacklist record and the corporate suffix is omitted. Given that the majority of information matches perfectly, and that the corporation name “Subex Systems” contains the fanciful descriptor “Subex”, it might be expected that the omission of the “Ltd.” suffix would barely, if at all, affect a final score. As the omission of a last name might highly problematic, the fraud detection device 340 might be configured to handle the situation in different ways depending on whether such an omission occurred in a new record or a blacklist record. For example, if the omission occurred in a new record, i.e., the record for a prospective new subscriber, the fraud detection device 340 might automatically reject the new subscriber, and send a special message to the respective client. On the other hand, should the omission occur in the blacklist record, the fraud detection device 340 might err to be over-inclusive or under-inclusive. Should the omission concern a middle-initial or middle-name, such differences may be weighted heavily, weighted lightly or altogether discounted.

FIG. 4G depicts a “specific word exclusion” match. As shown in FIG. 4G, a “specific word exclusion” match can be made to discount certain words entirely from consideration, especially commonly used corporate words or suffixes. For the example of FIG. 4G, the word “systems”, which may be considered a common/frequent word, is totally excluded from consideration while the term “Subex” being uncommon/fanciful is considered.

As opposed to total omission from consideration, common/frequent words may be heavily discounted in comparison to uncommon/fanciful words. For the example of FIG. 4G, a match for the word “Subex” might be heavily weighted while a match for the word “Systems” might be weighted a quarter as much.

FIG. 4H depicts a “minimum length” or “title exclusion” match. As shown in FIG. 4H, when a minimum length for words is required for consideration, the effect is to exclude short words, such as common personal titles or suffixes as well as corporate suffixes, from consideration. In contrast to a minimum length match, a title exclusion match might be designed to eliminate all titles and suffixes. For example, by eliminating the corporate suffixes “Limited” and “Ltd.” from consideration, a process akin to that of FIG. 4B (abbreviation match) might be realized with different accuracy.

As might be considered a variant to the abbreviation match or the title exclusion match, titles and suffixes also may be looked at for agreement or disagreement. For example, the title “Dr.” and the suffix “M.D.” might be considered perfect matches or substantial enough matches to consider. In comparison, the title “Dr.” and a suffix “Ph.D.” (Doctorate of Philosophy) might also be considered a perfect or substantial match while the title “Dr.” and a suffix “J.D.” (Doctorate of Jurisprudence) might me considered an unlikely match.

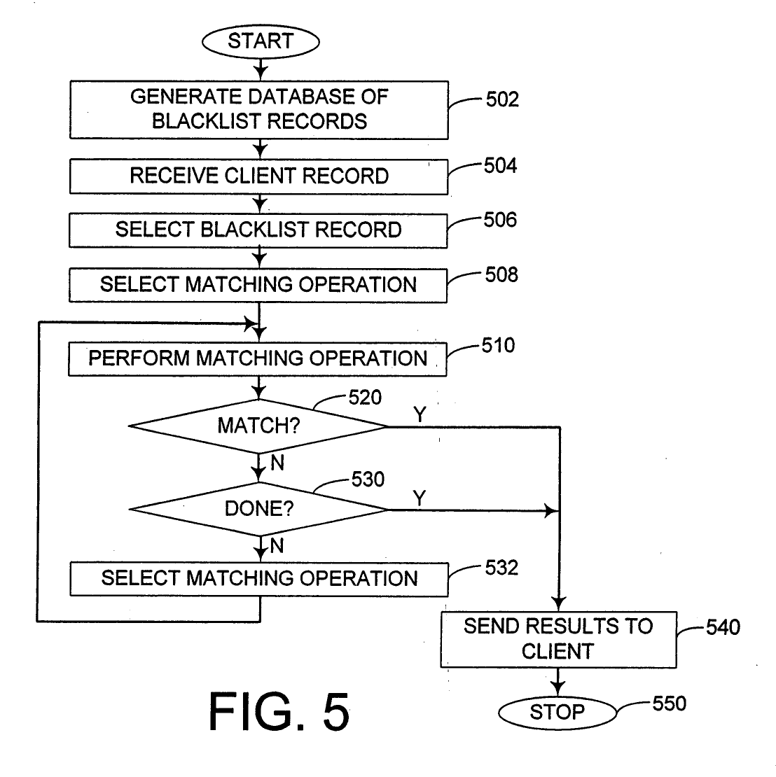

FIG. 5 is a flowchart outlining an exemplary operation according to the present disclosure for determining whether a prospective subscriber is likely to commit telecommunications fraud in a telecommunications network. The process starts in step 502 where a blacklist (or inclusively a “greylist”) of records are generated. As discussed above, such a list can be derived from a variety of sources, including competing companies, and can include a variety of fields of personal information. Next, in step 504, a prospective subscriber record from a client is received. Then, in step 506, a first blacklist record is selected for textual comparison. Control continues to step 508.

In step 508, a first textual matching operation is selected from a set of different matching operations, and can include any of those matching operations outlined above with regard to FIGS. 4A-4H as well as other matching operations not discussed. For the present embodiment, the hierarchy/ordering of matching operations can be made according to a variety of criteria, such as simplicity of processing and/or likelihood of producing the best matches. However, in other embodiments matching can be made according to any criteria or no criteria at all. Control continues to step 510.

In step 510, the matching operation selected in step 508 is performed between the respective fields of prospective subscriber record received in step 504 and the blacklist record selected in step 506. Next, in step 520, a determination is made as to whether there is a match between the two records. In the present embodiment, a match can be determined based on the scoring and threshold procedures discussed above. However, the exact procedures used to determine a match can vary from embodiment to embodiment as may be found advantageous. If a match is found, control jumps to step 540; otherwise, control continues to step 530.

In step 530, a determination is made as to whether textual matching between the two records is complete, i.e., all available matching techniques have been applied. If the textual matching operation between the two records is complete, control jumps to step 540; otherwise, control continues to step 532.

In step 532, the next textual matching operation in the hierarchy of operations is selected, and control jumps back to step 510 where the processes of steps 510-532 are repeated until either a match is found (step 520) or the available matching operations are exhausted (step 530).

In step 540, the results of a match (or lack of a match) can be sent to the client, and control continues to step 550 where the process stops, or optionally control can jump back to step 506 where another blacklist record can be selected for textual matching.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to fraud-detection related services.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for determining a likelihood that a new subscriber for a telecommunications-related service is likely to engage in telecommunications fraud, the apparatus comprising:
a blacklist database containing a plurality of dada records, each data record containing information on an individual assessed to be a telecommunications fraud risk; and
a fraud detection engine configured to perform one or more textual matching operations between a data record of the new subscriber and at least one record in the first database.

2. The apparatus of claim 1, wherein the database is derived from a plurality of unrelated companies each offering telecommunications services.

3. The apparatus of claim 1, wherein the new fraud detection engine is configured to perform a variety of different textual matching operations, one textual matching operation being an exact text match of at least one of a name, an address and an affiliated company of the new subscriber with a respective field of a first record of the blacklist database.

4. The apparatus of claim 3, wherein the new fraud detection engine is configured to perform a variety of different textual matching operations according to a hierarchy of textual matching operations, the hierarchy being based upon at least one of ease of processing or accuracy of results.

5. The apparatus of claim 4, wherein the hierarchy of textual matching operations includes an exact match, a phonetic match and a cross match.

6. The apparatus of claim 3, wherein another textual matching operation includes at least one of:
a textual match accounting for abbreviations of at least one of a name, an address and an affiliated company of the new subscriber and the first record of the blacklist database, and
a textual match accepting middle initials and middle names starting with the same middle initial as substantial equivalents.

7. The apparatus of claim 3, wherein another textual matching operation includes a phonetic text match between a field of the new subscriber and a respective field of the first record of the blacklist database.

8. The apparatus of claim 3, wherein another textual matching operation includes a minimum word match.

9. The apparatus of claim 3, wherein another textual matching operation includes a specific word exclusion process whereby any of a predetermined list of words are eliminated from consideration.

10. The apparatus of claim 3, wherein another textual matching operation includes a minimum-length word exclusion process whereby any word less than a proscribed length is eliminated from consideration.

11. The apparatus of claim 3, wherein another textual matching operation includes at least one of a title exclusion process or a title equating process.

12. The apparatus of claim 1, wherein the fraud detection engine is configured to perform one or more weighted textual matching operations to determine a likelihood that the new subscriber matches at least one record in the first database.

13. The apparatus of claim 12, wherein the one or more weights are determined based on a likelihood of meaningful equivalence.

14. The apparatus of claim 13, further comprising a threshold device configured to determine whether a matching operation of the fraud detection device results in a match.

15. An apparatus for determining a likelihood that a new subscriber for a telecommunications-related service is likely to engage in telecommunications fraud, the apparatus comprising:
a blacklist database containing a plurality of data records, each data record containing information on an individual assessed to be a telecommunications fraud risk; and
a fraud detection means for performing one or more textual matching operations between a data record of the new subscriber and at least one data record in the first database.

16. The apparatus of claim 15, further comprising a threshold means for determining whether a matching operation of the fraud detection means results in a match.

17. A method for determining a likelihood that a new subscriber for a telecommunications-related service is likely to engage in telecommunications fraud, the method comprising:
acquiring access to a blacklist database containing a plurality of dada records, each data record containing information on an individual assessed to be a telecommunications fraud risk; and
performing one or more textual matching operations between a data record of the new subscriber and at least one record in the first database.

18. The method of claim 17, wherein the step of performing one or more textual matching operations includes performing at least four of an exact word match, an abbreviation match, a cross match, a weighted match, a word match, a minimum percent match, a phonetic match, a minimum length match and an exclusion match.

19. The method of claim 18, wherein the step of performing one or more textual matching operations includes performing all of an exact word match, a cross match, a word match, a minimum percent match, a phonetic match, a minimum length match and an exclusion match.

20. The method of claim 18, wherein the step of performing one or more textual matching operations includes performing a threshold operation to determine whether a sum derived by the textual matching operations exceeds a proscribed threshold.
